(19) United States
(12) Patent Application Publication
(10) Pub. No.: US 2025/0192634 A1
(43) Pub. Date: Jun. 12, 2025

(54) COIL SUBSTRATE AND MOTOR COIL SUBSTRATE

(71) Applicant: IBIDEN CO., LTD., Ogaki (JP)

(72) Inventors: Haruhiko MORITA, Ogaki (JP); Hitoshi MIWA, Ogaki (JP); Shinobu KATO, Ogaki (JP); Toshihiko YOKOMAKU, Ogaki (JP); Hisashi KATO, Ogaki (JP); Takahisa HIRASAWA, Ogaki (JP); Tetsuya MURAKI, Ogaki (JP); Takayuki FURUNO, Ogaki (JP)

(73) Assignee: IBIDEN CO., LTD., Ogaki (JP)

(21) Appl. No.: 19/060,095

(22) Filed: Feb. 21, 2025

Related U.S. Application Data
(63) Continuation of application No. PCT/JP2022/032368, filed on Aug. 29, 2022.

(51) Int. Cl. H02K 3/28

(52) U.S. Cl. CPC H02K 3/28; H02K 2213/03

(57) ABSTRACT

A coil substrate includes a flexible substrate including a first substrate and a second substrate extending from the first substrate, and coils formed on the flexible substrate. The coils are positioned substantially in a row and include an m-th coil, an (m+1)-th coil, an (m+2)-th coil, an (m+3)-th coil, and an (m+4)-th coil. The (m+1)-th coil is positioned next to the m-th coil, the (m+2)-th coil is positioned next to the (m+1)-th coil, the (m+3)-th coil is positioned next to the (m+2)-th coil, the (m+4)-th coil is positioned next to the (m+3)-th coil, the m-th coil, the (m+1)-th coil, and the (m+2)-th coil partially overlap, and the m-th coil and the (m+4)-th coil do not overlap, where m is a natural number.

### CROSS-REFERENCE TO RELATED APPLICATIONS

The present application is a continuation of and claims the benefit of priority to International Application No. PCT/JP2022/032368, filed Aug. 29, 2022, the entire contents of which are incorporated herein by reference.

### BACKGROUND OF THE INVENTION

### Field of the Invention

The present invention relates to a coil substrate and a motor coil substrate.

### Description of Background Art

Japanese Patent Application Laid-Open Publication No. 2019-140762 describes a motor coil substrate having a flexible insulating substrate and coils. The entire contents of this publication are incorporated herein by reference.

### SUMMARY OF THE INVENTION

According to one aspect of the present invention, a coil substrate includes a flexible substrate including a first flexible substrate and a second flexible substrate extending from the first flexible substrate, and coils formed on the flexible substrate such that the coils are positioned substantially in a row. The coils include an m-th coil, an (m+1)-th coil, an (m+2)-th coil, an (m+3)-th coil, and an (m+4)-th coil such that the (m+1)-th coil is positioned next to the m-th coil, the (m+2)-th coil is positioned next to the (m+1)-th coil, the (m+3)-th coil is positioned next to the (m+2)-th coil, the (m+4)-th coil is positioned next to the (m+3)-th coil, the m-th coil, the (m+1)-th coil, and the (m+2)-th coil partially overlap, and the m-th coil and the (m+4)-th coil do not overlap, where m is a natural number.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a schematic diagram of a motor according to an embodiment of the present invention;

FIG. 1B is a schematic diagram of a motor coil substrate according to an embodiment of the present invention;

FIG. 1C is a plan view of a wiring according to an embodiment of the present invention;

FIG. 1D is a schematic diagram of a coil according to an embodiment of the present invention;

FIG. 1E is a cross-sectional view of a coil according to an embodiment of the present invention;

FIGS. 2A-2C are each a cross-sectional view of an inner coil according to an embodiment of the present invention;

FIGS. 3A and 3B are each a schematic diagram illustrating a cross section of a motor coil substrate according to an embodiment of the present invention; and

FIG. 4A is a plan view of a coil substrate according to an embodiment of the present invention; and

FIG. 4B illustrates a circumference of a virtual circle and a cross section of a part of a motor coil substrate according to an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

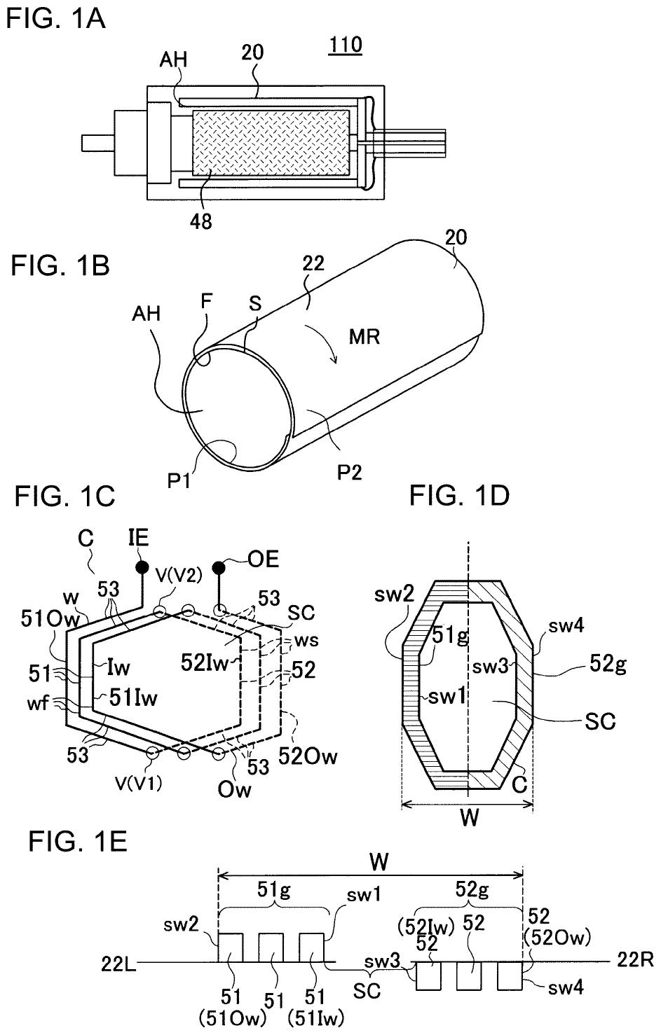

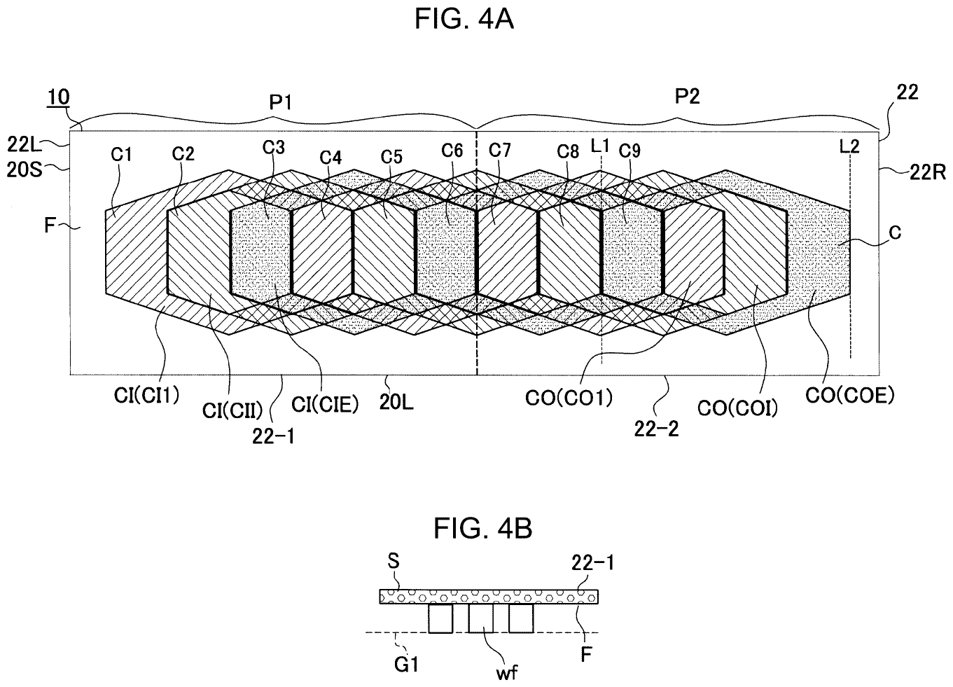

A coil substrate 10 illustrated in FIG. 4A is prepared. The coil substrate 10 is formed to include: a flexible substrate 22 having a first surface (F) and a second surface(S) on an opposite side with respect to the first surface (F); and coils (C) (C1-C9) on the flexible substrate 22. The flexible substrate 22 has a one-end (22L) and an other-end (22R). The coils (C) in FIG. 4A are schematically illustrated. By winding the coil substrate 10, a motor coil substrate 20 illustrated in FIG. 1B is obtained. For example, the coil substrate 10 is wound in a cylindrical shape. The motor coil substrate 20 is wound around a hollow space (AH). The coil substrate 10 is wound such that the first surface (F) faces the hollow space (AH). For example, the motor coil substrate 20 has a cylindrical shape. The number of windings (N) is 2 or more and 5 or less. FIG. 1B is a schematic diagram.

As illustrated in FIG. 1A, a motor 110 is obtained by positioning a magnet 48 inside the motor coil substrate 20. FIG. 1A is a schematic diagram. The motor coil substrate 20 is positioned around the magnet 48 via the hollow space (AH). An example of the motor 110 is a brushless motor. In the embodiment, the magnet 48 rotates. However, it is also possible that the motor coil substrate 20 rotates.

FIG. 1C illustrates an example of a coil (C). The coil (C) is formed of a central space (SC) and wirings (w) surrounding the central space (SC). The wiring (w) has an output part (OE) and an input part (IE). The wiring (w) is formed between the output part (OE) and the input part (IE). The wiring (w) forming the coil (C) is formed in a spiral shape. The central space (SC) is surrounded by an innermost wiring (Iw) of the wiring (w) forming the coil (C). An outermost wiring (w) is an outer side wiring (Ow). The wiring (w) forming the coil (C) is formed around the central space (SC).

The wiring (w) forming the coil (C) in FIG. 1C is drawn with solid lines, dashed lines, and circles. The solid lines indicate wirings on the first surface (F) (on-first-surface wirings) (wf). The dashed lines indicate wirings on the second surface(S) (on-second-surface wirings) (ws). The circles indicate via conductors (V). The via conductors (V) connect the on-first-surface wirings (wf) and the on-second-surface wirings (ws). The via conductors (V) include first via conductors (V1) that each connect an on-first-surface wiring (wf) and an on-second-surface wiring (ws) within one turn, and second via conductors (V2) that connect different turns. One on-first-surface wiring (wf), one first via conductor (V1), and one on-second-surface wiring (ws) form one turn.

As illustrated in FIG. 1C, the wiring (w) includes multiple first wirings 51 and multiple second wirings 52 that face each other across the central space (SC). In one coil (C), the first wirings 51 are close to the one-end (22L) and the second wirings 52 are close to the other-end (22R). The first wirings 51 are formed substantially parallel to each other. The second wirings 52 are formed substantially parallel to each other. The first wirings 51 and the second wirings 52 are formed substantially parallel to each other. When the motor 110 is manufactured using the coil substrate 10 of the embodiment, an angle between a rotation direction (MR) of the motor illustrated in FIG. 1B and the first wirings 51 is substantially 90 degrees. An angle between a direction of a current flowing through the first wirings 51 and the rotation direction (MR) of the motor is substantially 90 degrees. The wiring (w) further includes third wirings 53 that connect the first wirings 51 and the second wirings 52.

Among the multiple first wirings 51, an outermost first wiring 51 is an outer side first wiring (51Ow). Among the multiple first wirings 51, an innermost first wiring 51 is an inner side first wiring (51Iw). The inner side first wiring (51Iw) faces the central space (SC).

Among the multiple second wirings 52, an outermost second wiring 52 is an outer side second wiring (52Ow). Among the multiple second wirings 52, an innermost second wiring 52 is an inner side second wiring (52Iw). The inner side second wiring (52Iw) faces the central space (SC).

FIG. 1E is a cross-sectional view of one coil (C). FIG. 1E illustrates cross sections of the first wirings 51 and the second wirings 52.

FIG. 1D schematically illustrate a coil (C). In FIG. 1D, the wiring (w) is grouped. When the wiring (w) is grouped, a wiring group is formed. By grouping the first wirings 51, a first wiring group (51g) is formed. The first wiring group (51g) is formed by all the first wirings 51. By grouping the second wirings 52, a second wiring group (52g) is formed. The second wiring group (52g) is formed by all the second wirings 52. In FIG. 1D, the coil (C) is drawn using the wiring groups. The wiring group on the first surface (F) is drawn with horizontal lines. The wiring group on the second surface(S) is drawn with diagonal lines. The coils (C) in FIG. 4A are drawn using the wiring groups.

As illustrated in FIG. 4A, the flexible substrate 22 has a short side (20S) and a long side (20L). The flexible substrate 22 has the one-end (22L) and the other-end (22R) on an opposite side with respect to the one-end (22L). The short side (20S) also serves as the one-end (22L). The coils (C) (C1-C9) are formed along the long side (20L) of the flexible substrate 22. The coils (C) are formed substantially in one row from the one-end (22L) to the other-end (22R) of the flexible substrate 22. The coil (C) closest to the one-end (22L) is the first coil (C1). Next to the first coil (C1) is the second coil (C2). Next to the second coil (C2) is the third coil (C3). Next to the third coil (C3) is the fourth coil (C4). Next to the fourth coil (C4) is the fifth coil (C5). In this way, the (m+1)-th coil is positioned next to the m-th coil. The (m+2)-th coil is positioned next to the (m+1)-th coil. The (m+3)-th coil is positioned next to the (m+2)-th coil. The (m+4)-th coil is positioned next to the (m+3)-th coil. The first coil (C1), the second coil (C2), and the third coil (C3) partially overlap. The first coil (C1) and the fifth coil (C5) do not overlap. In this way, the m-th coil, the (m+1)-th coil, and the (m+2)-th coil partially overlap. The m-th coil and the (m+4)-th coil do not overlap. In the embodiment, three coils (C) overlap. Therefore, the space factor of the coils can be increased.

The first coil (C1), the second coil (C2), the third coil (C3), and the fourth coil (C4) partially overlap. The first coil (C1) and the fifth coil (C5) do not overlap. In this way, the m-th coil, the (m+1)-th coil, the (m+2)-th, and the (m+3)-th coil partially overlap. The m-th coil and the (m+4)-th coil do not overlap. In the embodiment, four coils (C) overlap. Therefore, the space factor of the coils can be increased.

The m-th coil is close to the one-end (22L), while the (m+1)-th coil is close to the other-end (22R). m is a natural number.

The first coil (C1) is a U-phase coil. The second coil (C2) is a V-phase coil. The third coil (C3) is a W-phase coil. The U-phase coil, the V-phase coil, and the W-phase coil are formed in the order of the U-phase coil, the V-phase coil, and the W-phase coil, with the coil (C) closest to the one-end (22L) being the U-phase coil. The number of coils (C) is a multiple of 3. In the example of FIG. 4A, the number of the coils is 9.

The coil substrate 10 is formed of the one flexible substrate 22. The flexible substrate 22 forming the coil substrate 10 is divided into multiple portions (P). Therefore, the coil substrate 10 is also divided into multiple portions (P). The coil substrate 10 is formed of the multiple portions (P), and the number of the portions (P) is N. The portions (P) forming the coil substrate 10 are formed from the one-end (22L) to the other-end (22R). The first portion (P1) includes the one-end (22L) of the flexible substrate 22. The second portion (P2) is next to the first portion (P1). For example, N is the number of windings of the flexible substrate 22. The N-th portion (PN) includes the other-end (22R) of the flexible substrate 22.

In the example of FIG. 4A, the number of the portions (P) is 2. The coil substrate 10 of FIG. 4A is formed of the first portion (P1) and the second portion (P2). The flexible substrate 22 forming the first portion (P1) is a first flexible substrate (22-1). The flexible substrate 22 forming the second portion (P2) is a second flexible substrate (22-2). The second flexible substrate (22-2) extends from the first flexible substrate (22-1).

As illustrated in FIG. 4A, the coils (C) include coils (C) formed in the first flexible substrate (22-1), coils (C) formed in the second flexible substrate (22-2), and coils formed in both the first flexible substrate (22-1) and the second flexible substrate (22-2).

The coils (C) formed in the first flexible substrate (22-1) are referred to as inner coils (CI). In the case of the inner coils (CI), the coils (C) are entirely formed in the first flexible substrate (22-1). The number of the inner coils (CI) (first number) is 2 or more. Among the inner coils (CI), the coil (C) closest to the one-end (22L) is the first inner coil (CI1). Among the inner coils (CI), the coil (C) closest to the second flexible substrate (22-2) is the last inner coil (CIE). The inner coils (CI) include intermediate inner coils (CII) between the first inner coil (CI1) and the last inner coil (CIE). The number of the intermediate inner coils (CII) is 1 or 4.

In the example of FIG. 4A, the first number is 3, and there is one intermediate inner coil (CII). The first inner coil (CI1), the intermediate inner coil (CII), and the last inner coil (CIE) are formed on the first flexible substrate (22-1). The first coil (C1) is the first inner coil (CI1). The second coil (C2) is the intermediate inner coil (CII). The third coil (C3) is the last inner coil (CIE).

The coils (C) formed on the second flexible substrate (22-2) are referred to as outer coils (CO). In the case of the outer coils (CO), the coils (C) are entirely formed in the second flexible substrate (22-2). The number of the outer coils (CO) (second number) is 2 or more. The first number and the second number are the same. Among the outer coils (CO), the coil (C) closest to the first flexible substrate (22-1) is the first outer coil (CO1). Among the outer coils (CO), the coil (C) closest to the other-end (22R) is the last outer coil (COE). The outer coils (CO) include intermediate outer coils (COI) between the first outer coil (CO1) and the last outer coil (COE). The number of the intermediate outer coils (COI) is 1 or 4. The seventh coil (C7) is the first outer coil (CO1). The eighth coil (C8) is the intermediate outer coil (COI). The ninth coil (C9) is the last outer coil (COE).

In the example of FIG. 4A, the second number is 3, and there is one intermediate outer coil (COI). The first outer coil (CO1), the intermediate outer coil (COI), and the last outer coil (COE) are formed on the second flexible substrate (22-2).

Each coil (C) has a distance (width) (W) illustrated in FIGS. 1D and 1E. The first wirings 51 have a first sidewall (sw1) facing the central space (SC) and a second sidewall (sw2) on an opposite side with respect to the first sidewall (sw1). The second wirings 52 have a third sidewall (sw3) facing the central space (SC) and a fourth sidewall (sw4) on an opposite side with respect to the third sidewall (sw3). In the wiring (w) forming one coil (C), a distance between the second sidewall (sw2) of the outer side first wiring (51Ow) and the fourth sidewall (sw4) of the outer side second wiring (52Ow) is the width (W). Or, the width (W) is measured along a straight line perpendicular to the first wirings 51. Or, the width (W) is measured along the long side (20L) of the flexible substrate 22. Or, two straight lines (a first straight line (L1) and a second straight line (L2)) are prepared on the coil substrate 10 illustrated in FIG. 4A. The first straight line (L1) and the second straight line (L2) are parallel to each other. An angle between the first straight line (L1) and the rotation direction (MR) of the motor 110 is substantially 90 degrees. Each coil (C) is sandwiched between the first straight line (L1) and the second straight line (L2). A distance between the first straight line (L1) and the second straight line (L2) that sandwich a coil (C) is the width (W) of the coil (C). The first inner coil (CI1) has a first width (w1). The intermediate inner coil (CII) has a first width (w1). The last inner coil (CIE) has a second width (w2). For example, when the first inner coil (CI1) is sandwiched between the first straight line (L1) and the second straight line (L2), the distance between the first straight line (L1) and the second straight line (L2) is the first width (w1). When the last inner coil (CIE) is sandwiched between the first straight line (L1) and the second straight line (L2), the distance between the first straight line (L1) and the second straight line (L2) is the second width (w2). When the intermediate inner coil (CII) is sandwiched between the first straight line (L1) and the second straight line (L2), the distance between the first straight line (L1) and the second straight line (L2) is the first width (w1).

The central space (SP) of each coil (C) has a width. The width of the central space (SP) is a distance between the first sidewall (sw1) of the inner side first wiring (51Iw) and the third sidewall (sw3) of the inner side second wiring (52Iw). Or, the width is measured by sandwiching the central space (SP) between a first straight line and a second straight line. The distance between the first straight line and the second straight line is the width of the central space (SP).

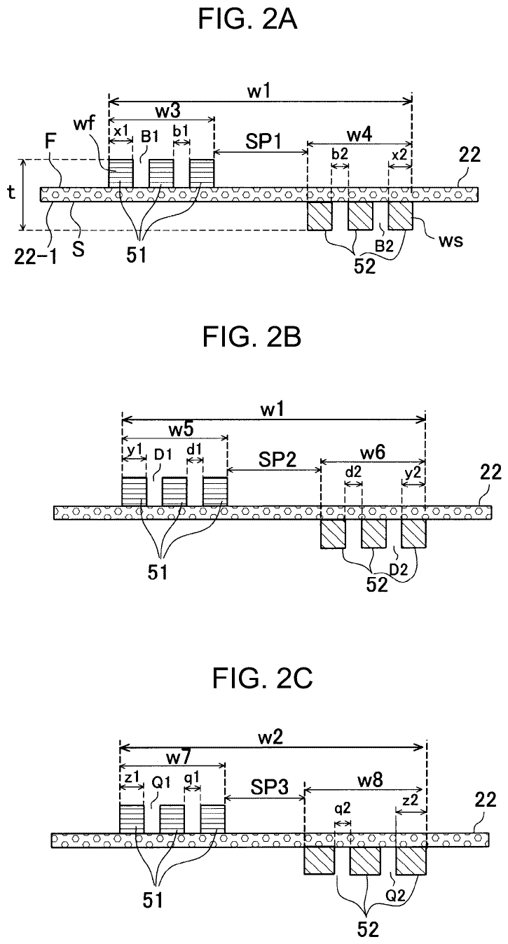

FIGS. 2A-2C illustrate the width (W) of the first inner coil (CI1), the width (W) of the intermediate inner coil (CII), and the width (W) of the last inner coil (CIE). The width of the first inner coil (CI1) (first width (w1)) and the width of the intermediate inner coil (CII) (first width (w1)) are substantially equal to each other. The width of the last inner coil (CIE) (second width (w2)) is larger than the first width (w1).

FIG. 2A illustrates a cross section of the first inner coil (CI1). FIG. 2B illustrates a cross section of the intermediate inner coil (CII). FIG. 2C illustrates a cross section of the last inner coil (CIE). These drawings illustrate cross sections of the first wirings 51 and the second wirings 52.

The first wirings 51 forming the first inner coil (CI1) each have a width (eleventh width) (x1). The first wirings 51 in the first inner coil (CI1) have substantially the same widths (x1).

Spaces (B1) are formed between adjacent first wirings 51 in the first inner coil (CI1). The spaces (B1) each have a width (b1). The spaces (B1) in the first inner coil (CI1) have substantially the same width (twenty-first width) (b1).

The second wirings 52 forming the first inner coil (CI1) each have a width (twelfth width) (x2). The second wirings 52 in the first inner coil (CI1) have substantially the same width (x2).

Spaces (B2) are formed between adjacent second wirings 52 in the first inner coil (CI1). The spaces (B2) each have a width (twenty-second width) (b2). The spaces (B2) in the first inner coil (CI1) have substantially the same width (b2).

The first wirings 51 forming the intermediate inner coil (CII) each have a width (thirteenth width) (y1). The first wirings 51 in the intermediate inner coil (CII) have substantially the same width (y1).

Spaces (D1) are formed between adjacent first wirings 51 in the intermediate inner coil (CII). The spaces (D1) each have a width (twenty-third width) (d1). The spaces (D1) in the intermediate inner coil (CII) have substantially the same width (d1).

The second wirings 52 forming the intermediate inner coil (CII) each have a width (fourteenth width) (y2). The second wirings 52 in the intermediate inner coil (CII) have substantially the same width (y2).

Spaces (D2) are formed between adjacent second wirings 52 in the intermediate inner coil (CII). The spaces (D2) each have a width (twenty-fourth width) (d2). The spaces (D2) in the intermediate inner coil (CII) have substantially the same width (d2).

The first wirings 51 forming the last inner coil (CIE) each have a width (fifteenth width) (z1). The first wirings 51 in the last inner coil (CIE) have substantially the same width (z1).

Spaces (Q1) are formed between adjacent first wirings 51 in the last inner coil (CIE). The spaces (Q1) each have a width (twenty-fifth width) (q1). The spaces (Q1) in the last inner coil (CIE) have substantially the same width (q1).

The second wirings 52 forming the last inner coil (CIE) each have a width (sixteenth width) (z2). The second wirings 52 in the last inner coil (CIE) have substantially the same width (z2).

Spaces (Q2) are formed between adjacent second wirings 52 in the last inner coil (CIE). The spaces (Q2) each have a width (twenty-sixth width) (q2). The spaces (Q2) in the last inner coil (CIE) have substantially the same width (q2).

The eleventh width (x1), the twelfth width (x2), the thirteenth width (y1), the fourteenth width (y2), and the fifteenth width (z1) are substantially equal. The sixteenth width (z2) is larger than the eleventh width (x1).

The twenty-first width (b1), the twenty-second width (b2), the twenty-third width (d1), the twenty-fourth width (d2), the twenty-fifth width (q1), and the twenty-sixth width (q2) are substantially equal.

A width (SP1) of the central space (SP) of the first inner coil (CI1), a width (SP2) of the central space (SP) of the intermediate inner coil (CII), and a width (SP3) of the central space (SP) of the last inner coil (CIE) are substantially equal.

Based on this relationship, the width (w2) of the last inner coil (CIE) can be made larger than the width (w1) of the first inner coil (CI1). The width (w2) of the last inner coil (CIE) can be made larger than the width (w1) of the intermediate inner coil (CII). The width (w2) of the last inner coil (CIE) is adjusted by adjusting the sixteenth width (z2). The width (w1) of the first inner coil (CI1) and the width (w1) of the intermediate inner coil (CII) can be made substantially equal.

The first wiring group (51g) has a width. The width of the first wiring group (51g) is a distance between the second sidewall (sw2) of the outer side first wiring (51Ow) and the first sidewall (sw1) of the inner side first wiring (51Iw). Or, the width of the first wiring group (51g) is measured along a straight line perpendicular to the first wirings 51. Or, the width is measured by sandwiching the first wiring group (51g) between the first straight line (L1) and the second straight line (L2). The distance between the first straight line (L1) and the second straight line (L2) is the width of the first wiring group (51g).

The second wiring group (52g) has a width. The width of the second wiring group (52g) is a distance between the fourth sidewall (sw4) of the outer side second wiring (52Ow) and the third sidewall (sw3) of the inner side second wiring (52Iw). Or, the width of the second wiring group (52g) is measured along a straight line perpendicular to the first wirings 51. Or, the width is measured by sandwiching the second wiring group (52g) between the first straight line (L1) and the second straight line (L2). The distance between the first straight line (L1) and the second straight line (L2) is the width of the second wiring group (52g).

As illustrated in FIG. 2A, the first wiring group (51g) of the first inner coil (CI1) has a first wiring group width (thirty-first width) (w3). The second wiring group (52g) of the first inner coil (CI1) has a second wiring group width (thirty-second width) (w4).

As illustrated in FIG. 2B, the first wiring group (51g) of the intermediate inner coil (CII) has a first wiring group width (thirty-third width) (w5). The second wiring group (52g) of the intermediate inner coil (CII) has a second wiring group width (thirty-fourth width) (w6).

As illustrated in FIG. 2C, the first wiring group (51g) of the last inner coil (CIE) has a first wiring group width (thirty-fifth width) (w7). The second wiring group (52g) of the last inner coil (CIE) has a second wiring group width (thirty-sixth width) (w8).

The thirty-first width (w3), the thirty-second width (w4), the thirty-third width (w5), the thirty-fourth width (w6), and the thirty-fifth width (w7) are substantially equal. The thirty-sixth width (w8) is larger than the thirty-first width (w3).

A width (SP1) of the central space (SP) of the first inner coil (CI1), a width (SP2) of the central space (SP) of the intermediate inner coil (CII), and a width (SP3) of the central space (SP) of the last inner coil (CIE) are substantially equal.

Based on this relationship, the width (w2) of the last inner coil (CIE) can be made larger than the width (w1) of the first inner coil (CI1). The width (w2) of the last inner coil (CIE) is adjusted by adjusting the thirty-sixth width (w8). The width (w2) of the last inner coil (CIE) can be made larger than the width (w1) of the intermediate inner coil (CII). The width (w1) of the first inner coil (CI1) and the width (w1) of the intermediate inner coil (CII) can be made substantially equal.

By winding the coil substrate 10, the motor coil substrate 20 of the embodiment is obtained. The coil substrate 10 is wound such that the portions (P) each form substantially one turn. An example of a method for winding the coil substrate 10 is described using FIG. 1B. When the coil substrate 10 of FIG. 4A is wound, the first portion (P1) forms substantially one turn. The second portion (P2) connected to the first portion (P1) forms substantially one turn. As illustrated in FIG. 1B, the first portion (P1) is wound on an inner side. The first portion (P1) forms the first turn. The flexible substrate 22 forming the first portion (P1) is a first flexible substrate (22-1). The second portion (P2) is wound on an outer side of the first portion (P1). The second portion (P2) forms the second turn. The flexible substrate 22 forming the second portion (P2) is a second flexible substrate (22-2).

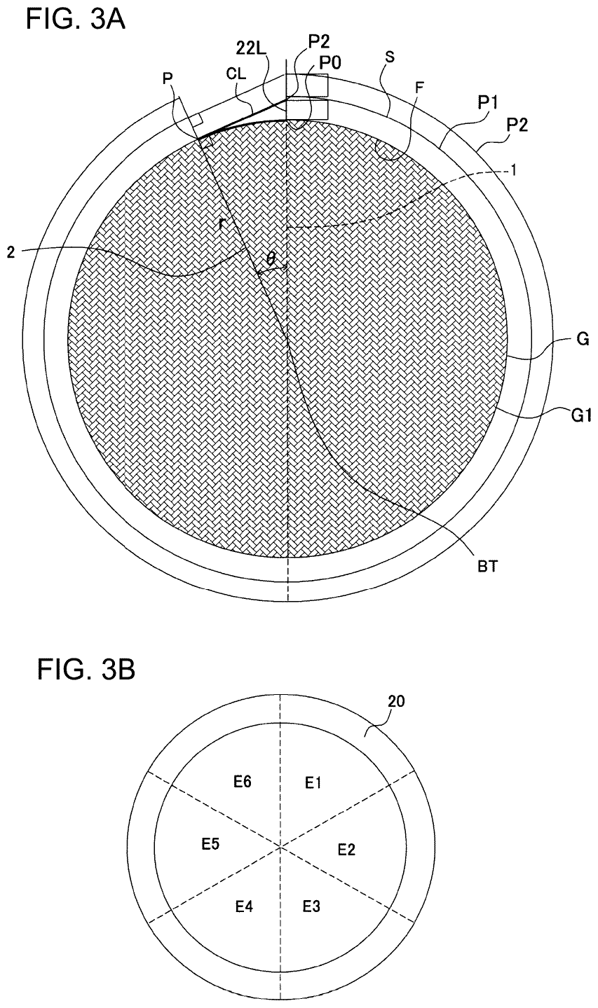

FIG. 3B schematically illustrates a cross section of the motor coil substrate 20. In FIG. 3B, the motor coil substrate 20 is cut in a plane parallel to the rotation direction (MR) of the motor 110. As illustrated in FIG. 3B, the motor coil substrate 20 can be divided into equal areas. In each area, a first wiring group (51g) or a second wiring group (52g) is formed. Or, in each area, a first wiring group (51g) and a second wiring group (52g) are formed. In this case, a first wiring group (51g) and a second wiring group (52g) of the same phase are formed in one area. For example, a first wiring group (51g) forming a U-phase coil and a second wiring group (52g) forming a U-phase coil are formed. When multiple wiring groups are formed in one area, each wiring group formed in that area forms a different coil (C). The first wiring group (51g) and the second wiring group (52g) in one coil (C) are not formed in one area. The first wiring group (51g) and the second wiring group (52g) in one coil (C) are not formed in the same area.

In FIG. 3B, the motor coil substrate 20 is divided into six areas. A central angle of each area is substantially 60 degrees. The area between 0 and 60 degrees is the first area (E1). The area between 60 and 120 degrees is the second area (E2). Next to the second area (E2) is the third area (E3). Next to the third area (E3) is the fourth area (E4). Next to the fourth area (E4) is the fifth area (E5). Next to the fifth area (E5) is the sixth area (E6).

In the first area (E1), the first wiring group (51g) of the first coil (C1), the second wiring group (52g) of the fourth coil (C4), and the first wiring group (51g) of the seventh coil (C7) are formed. In the second area (E2), the first wiring group (51g) of the second coil (C2), the second wiring group (52g) of the fifth coil (C5), and the first wiring group (51g) of the eighth coil (C8) are formed. In the third area (E3), the first wiring group (51g) of the third coil (C3), the second wiring group (52g) of the sixth coil (C6), and the first wiring group (51g) of the ninth coil (C9) are formed. In the fourth area (E4), the second wiring group (52g) of the first coil (C1), the first wiring group (51g) of the fourth coil (C4), and the second wiring group (52g) of the seventh coil (C7) are formed. In the fifth area (E5), the second wiring group (52g) of the second coil (C2), the first wiring group (51g) of the fifth coil (C5), and the second wiring group (52g) of the eighth coil (C8) are formed. In the sixth area (E6), the second wiring group (52g) of the third coil (C3), the first wiring group (51g) of the sixth coil (C6), and the second wiring group (52g) of the ninth coil (C9) are formed.

A substrate having a first-turn substrate and a second-turn substrate, and a circle (r) having a radius (R) are prepared. Coils are formed on the first-turn substrate. Coils are formed on the second-turn substrate. The first-turn substrate and the length of the second-turn substrate each have a length of 2πR. The first-turn substrate extends from a start portion to an end portion. The second-turn substrate extends from a start portion to an end portion. The end portion of the first-turn substrate aligns with the start portion of the second-turn substrate. The substrate is wound such that the second-turn substrate is wrapped around the first-turn substrate. In this case, the substrate is wound such that the first-turn substrate is positioned on the circumference of the circle (r). Then, the second-turn substrate is wound around the first-turn substrate. Therefore, the second-turn substrate is not positioned on the circumference of the circle (r). The second-turn substrate is positioned on an outer side of the circumference of the circle (r). Therefore, the start portion of the second-turn substrate is not positioned directly above the start portion of the first-turn substrate. Consequently, it is difficult to align the positions of the coils on the first-turn substrate with the positions of the coils on the second-turn substrate.

According to the coil substrate 10 of the embodiment, the width of the last inner coil (CIE) (second width (w2)) is larger than the width of the first inner coil (CI1) (first width (w1)). As a result, the length of the first flexible substrate (22-1) is adjusted. Therefore, even when the second flexible substrate (22-2) is wound around the first flexible substrate (22-1), as in Patent Document 1, the position of the first inner coil (CI1) and the position of the first outer coil (CO1) can be aligned with high precision. The position of the intermediate inner coil (CII) and the position of the intermediate outer coil (COI) can be aligned with high precision. The position of the last inner coil (CIE) and the position of the last outer coil (COE) can be aligned with high precision. As a result, a motor coil substrate 20 with a high space factor can be obtained.

The motor coil substrate 20 of the embodiment is cut along a plane that includes the rotation direction (MR) of the motor. For example, the motor coil substrate 20 is cylindrical. An example of the cross-sectional shape obtained by the cutting is illustrated in FIG. 3A. The shape illustrated in FIG. 3A is substantially circular.

A virtual circle (G) is drawn in FIG. 3A. The virtual circle (G) has a radius (r) and a circumference (G1). As illustrated in FIG. 4B, upper surfaces of the on-first-surface wirings (wf) of the first flexible substrate (22-1) are positioned on the circumference (G1). The coil substrate that forms the motor coil substrate 20 has a thickness (t). As illustrated in FIG. 2A, the thickness (t) is a sum of a thickness of the first flexible substrate (22-1), a thickness of the on-first-surface wirings (wf) on the first flexible substrate (22-1), and a thickness of the on-second-surface wirings (ws) on the first flexible substrate (22-1). An intersection point (PO) of an extension line of the one-end (22L) and the circumference (G1) is illustrated in FIG. 3A. An intersection point (P2) of the extension line of the one-end (22L) and an extension line of the upper surfaces of the on-second-surface wirings (ws) on the first flexible substrate (22-1) is illustrated in FIG. 3A. A straight line (CL) passing through the intersection point (P2) and tangent to the virtual circle (G) is illustrated in FIG. 3A. As illustrated in FIG. 3A, the straight line (CL) and the virtual circle (G) are tangent at a point (P). A center (BT) of the virtual circle (G) is illustrated in FIG. 3A. An angle (θ) between a straight line 1 passing through the intersection point (PO) and the center (BT) and a straight line 2 passing through the point (P) and the center (BT) is illustrated in FIG. 3A.

A difference (δ) between the second width (w2) and the first width (w1) satisfies Relational Expression 1, which includes the radius (r), the thickness (t), and the angle (θ). The angle (θ) satisfies Relational Expression 2.

$$δ = ( r + t ) sin θ - 2 π r θ / 360 \qquad Relational Expression 1$$

$$θ = {cos}^{- 1} ( r / ( r + t ) ) \qquad Relational Expression 2$$

When the difference (δ) between the second width (w2) and the first width (w1) satisfies Relational Expression 1, the positions of the inner coils (CI) and the outer coils (CO) can be aligned with high precision.

The width (w3) of the first wiring group of the first inner coil (CII) is equal to the width (w7) of the first wiring group of the last inner coil (CIE). Further, the width (w8) of the second wiring group of the last inner coil (CIE) is larger than the width (w4) of the second wiring group of the first inner coil (CI1). In this case, the difference (δ) between the width (w8) of the second wiring group of the last inner coil (CIE) and the width (w4) of the second wiring group of the first inner coil (CI1) satisfies Relational Expression 1.

An insulating film can be formed on the first surface (F) of the flexible substrate 22 and the on-first-surface wirings (wf). An insulating film can be formed on the second surface(S) of the flexible substrate 22 and the on-second-surface wirings (ws). When the insulating films are formed, the coil substrate 10 includes the insulating films. When the coil substrate 10 includes the insulating films, the thickness (t) includes thicknesses of the insulating films.

Regarding the width (W) of each of the coils (C), the inner coils (CI) and the outer coils (CO) have the relationship. The width of the first outer coil (CO1) and the width of the intermediate outer coil (COI) are substantially equal. The width of the last outer coil (COE) is larger than the width of the first outer coil (CO1). The width of the last outer coil (COE) is adjusted by the width of the second wirings 52 of the last outer coil (COE). In the last outer coil (COE), the second wirings 52 have a larger width than the first wirings 51. The width of the last outer coil (COE) is adjusted by the width of the second wiring group (52g) of the last outer coil (COE). In the outer coil (COE), the second wiring group (52g) has a larger width than the first wiring group (51g). In this way, the widths (W) of the coils (C) are adjusted using the same method for both the inner coils (CI) and the outer coils (CO).

FIG. 5 of Japanese Patent Application Laid-Open Publication No. 2019-140762 illustrates an arrangement of coils. According to FIG. 5 of Japanese Patent Application Laid-Open Publication No. 2019-140762, a coil (C1) and a coil (C2) partially overlap. The coil (C1) and a coil (C3) do not overlap. Therefore, it is difficult to increase a space factor of the coils using the technology of Japanese Patent Application Laid-Open Publication No. 2019-140762.

In the motor coil substrate of Japanese Patent Application Laid-Open Publication No. 2019-140762, the flexible insulating substrate is wound. The number of turns the flexible insulating substrate is wound is more than one turn. Therefore, it is thought that the motor coil substrate of Patent Document 1 includes, at least, a first-turn flexible insulating substrate (first flexible insulating substrate) and a second-turn flexible insulating substrate (second flexible insulating substrate) wound on an outer side of the first flexible insulating substrate. A first portion of the second flexible insulating substrate extends from a last portion of the first flexible insulating substrate. The second flexible insulating substrate is wound around the first flexible insulating substrate. When the flexible insulating substrate is wound such that the flexible insulating substrate has a cylindrical shape, it is thought that a distance between a center of the cylinder and the first portion of the first flexible insulating substrate differs from a distance between the center of the cylinder and the last portion of the first flexible insulating substrate. In the technology of Japanese Patent Application Laid-Open Publication No. 2019-140762, it is thought that a position of a coil formed on the first portion of the first flexible insulating substrate does not align with a position of a coil formed on the first portion of the second flexible insulating substrate. When a motor is formed using the technology of Japanese Patent Application Laid-Open Publication No. 2019-140762, it is thought difficult to provide a motor with high performance.

A coil substrate according to an embodiment of the present invention includes a flexible substrate that includes a first flexible substrate having a one-end and a second flexible substrate extending from the first flexible substrate, and multiple coils that are formed on the flexible substrate. The coils are formed substantially in a row. The coils include an m-th coil, an (m+1)-th coil, an (m+2)-th coil, an (m+3)-th coil, and an (m+4)-th coil. The (m+1)-th coil is positioned next to the m-th coil. The (m+2)-th coil is positioned next to the (m+1)-th coil. The (m+3)-th coil is positioned next to the (m+2)-th coil. The (m+4)-th coil is positioned next to the (m+3)-th coil. The m-th coil, the (m+1)-th coil, and the (m+2)-th coil partially overlap. The m-th coil and the (m+4)-th coil do not overlap. m is a natural number.

In an embodiment of the present invention, the coil substrate is formed of a flexible substrate that includes a first flexible substrate and a second flexible substrate extending from the first flexible substrate, and multiple coils that are formed on the flexible substrate. The m-th coil, the (m+1)-th coil, and the (m+2)-th coil partially overlap. According to the embodiment, at least three coils overlap. Therefore, the space factor of the coils can be increased.

A motor coil substrate can be manufactured by winding the coil substrate of the embodiment. The second flexible substrate is wound around the first flexible substrate. The first flexible substrate forms a first turn, and the second flexible substrate forms a second turn. Coils on the first flexible substrate are inner coils, and coils on the second flexible substrate are outer coils. The number of the inner coils (first number) and the number of the outer coils (second number) are both 2 or more, and the first number and the second number are the same. The inner coils include a first inner coil, which is closest to the one-end of the first flexible substrate, and a last inner coil, which is closest to the second flexible substrate. The last inner coil has a second width, and the first inner coil has a first width. The second width is larger than the first width. By adjusting the second width, a length of the first flexible substrate can be adjusted. By adjusting the second width, positions of the coils in the motor coil substrate can be adjusted. According to the embodiment, the positions of the inner coils and the positions of the outer coils can be aligned with high precision. A motor coil substrate having high performance can be provided.

Obviously, numerous modifications and variations of the present invention are possible in light of the above teachings. It is therefore to be understood that within the scope of the appended claims, the invention may be practiced otherwise than as specifically described herein.

1. A coil substrate, comprising:
a flexible substrate comprising a first flexible substrate and a second flexible substrate extending from the first flexible substrate; and
a plurality of coils formed on the flexible substrate such that the plurality of coils is positioned substantially in a row,
wherein the plurality of coils includes an m-th coil, an (m+1)-th coil, an (m+2)-th coil, an (m+3)-th coil, and an (m+4)-th coil such that the (m+1)-th coil is positioned next to the m-th coil, the (m+2)-th coil is positioned next to the (m+1)-th coil, the (m+3)-th coil is positioned next to the (m+2)-th coil, the (m+4)-th coil is positioned next to the (m+3)-th coil, the m-th coil, the (m+1)-th coil, and the (m+2)-th coil partially overlap, and the m-th coil and the (m+4)-th coil do not overlap, where m is a natural number.

2. The coil substrate according to claim 1, wherein the m-th coil, the (m+1)-th coil, the (m+2)-th coil, and the (m+3)-th coil partially overlap.

3. A motor coil substrate, comprising:
the coil substrate of claim 1 formed such that the second flexible substrate is configured to be wound around the first flexible substrate, the first flexible substrate forms a first turn, the second flexible substrate forms a second turn, the coils on the first flexible substrate are inner coils, and the coils on the second flexible substrate are outer coils,
wherein a number of the inner coils and a number of the outer coils are 2 or more and a same number, respectively, the inner coils include a first inner coil closest to one-end of the first flexible substrate and a last inner coil closest to the second flexible substrate, and each of the coils has a width such that a width of the last inner coil is a second width, a width of the first inner coil is a first width, and the second width is larger than the first width.

4. The motor coil substrate according to claim 3, wherein the flexible substrate has a short side and a long side, the coils are formed along the long side, and the width of each of the coils is measured along the long side.

5. The motor coil substrate according to claim 3, wherein the motor coil substrate is configured to be wound around a magnet of a motor such that when the last inner coil is sandwiched between a first straight line and a second straight line perpendicular to a rotation direction of the motor, a distance between the first straight line and the second straight line is the second width of the last inner coil, and when the first inner coil is sandwiched between the first straight line and the second straight line, a distance between the first straight line and the second straight line is the first width of the first inner coil.

6. The motor coil substrate according to claim 3, wherein the inner coils include an intermediate inner coil between the first inner coil and the last inner coil such that a width of the intermediate inner coil and the width of the first inner coil are substantially equal.

7. The motor coil substrate according to claim 3, wherein each of the coils includes a wiring formed around a central space such that a number of turns of each of the coils is 2 or more, the wiring includes a plurality of first wirings and a plurality of second wirings facing the plurality of first wirings across the central space such that the first wirings are substantially parallel to each other, the second wirings are substantially parallel to each other, and the first wirings and the second wirings are substantially parallel to each other, the first wirings form a first wiring group having a first wiring group width, and the second wirings form a second wiring group having a second wiring group width such that the first wiring group width and the second wiring group width are substantially equal in the first inner coil, and the first wiring group width and the second wiring group with are different in the last inner coil.

8. The motor coil substrate according to claim 3, wherein the flexible substrate is configured to be would such that a number of windings N is in a range of 2 to 5.

9. The motor coil substrate according to claim 3, wherein the plurality of coils includes a plurality of U-phase coils, a plurality of V-phase coils, and a plurality of W-phase coils.

10. The motor coil substrate according to claim 7, wherein the first and second wirings are formed such that the second wiring group width is larger than the first wiring group width in the last inner coil.

11. The motor coil substrate according to claim 7, wherein the inner coils include an intermediate inner coil between the first inner coil and the last inner coil such that the first wiring group width and the second wiring group width are substantially equal in the intermediate inner coil.

12. The motor coil substrate according to claim 7, wherein the inner coils on the first flexible substrate are entirely positioned in the first flexible substrate, and the outer coils are entirely positioned in the second flexible substrate.

13. The motor coil substrate according to claim 7, wherein when the motor coil substrate is configured to be wound around a magnet such that an angle between a rotation direction of the motor and the first wirings is substantially 90 degrees.

14. The motor coil substrate according to claim 13, wherein the flexible substrate has a first surface and a second surface on an opposite side with respect to the first surface, the plurality of coils includes on-first-surface wirings formed on the first surface and on-second-surface wirings formed on the second surface such that when the coil substrate is wound, the first surface faces the magnet, the motor coil substrate is configured to be positioned such that upper surfaces of the on-first-surface wirings formed on the first flexible substrate substantially overlap with a circumference of a virtual circle formed in a cross section of the motor coil substrate in a plane parallel to the rotation direction of the motor, a difference (δ) between the second width and the first width satisfies Expression 1, δ=(r+t)sinθ−2πrθ/360, and Expression 2, θ=cos⁻¹(r/(r+t)), wherein r is a radius of the virtual circle, t is a sum of a thickness of the flexible substrate, a thickness of the on-first-surface wirings, and a thickness of the on-second-surface wirings, and θ is determined from the Expression 2.

15. The motor coil substrate according to claim 14, further comprising:
an insulating film formed on the first flexible substrate and the inner coils,
wherein the t includes a thickness of the insulating film, the thickness of the flexible substrate, the thickness of the on-first-surface wirings, and the thickness of the on-second-surface wirings.

16. A motor coil substrate, comprising:
the coil substrate of claim 2 formed such that the second flexible substrate is configured to be wound around the first flexible substrate, the first flexible substrate forms a first turn, the second flexible substrate forms a second turn, the coils on the first flexible substrate are inner coils, and the coils on the second flexible substrate are outer coils,
wherein a number of the inner coils and a number of the outer coils are 2 or more and a same number, respectively, the inner coils include a first inner coil closest to one-end of the first flexible substrate and a last inner coil closest to the second flexible substrate, and each of the coils has a width such that a width of the last inner coil is a second width, a width of the first inner coil is a first width, and the second width is larger than the first width.

17. The motor coil substrate according to claim 16, wherein the flexible substrate has a short side and a long side, the coils are formed along the long side, and the width of each of the coils is measured along the long side.

18. The motor coil substrate according to claim 16, wherein the motor coil substrate is configured to be wound around a magnet of a motor such that when the last inner coil is sandwiched between a first straight line and a second straight line perpendicular to a rotation direction of the motor, a distance between the first straight line and the second straight line is the second width of the last inner coil, and when the first inner coil is sandwiched between the first straight line and the second straight line, a distance between the first straight line and the second straight line is the first width of the first inner coil.

19. The motor coil substrate according to claim 16, wherein the inner coils include an intermediate inner coil between the first inner coil and the last inner coil such that a width of the intermediate inner coil and the width of the first inner coil are substantially equal.

20. A motor, comprising:
a magnet; and
the motor coil substrate of claim 3 wound around the magnet,
wherein when the last inner coil is sandwiched between a first straight line and a second straight line perpendicular to a rotation direction of the motor, a distance between the first straight line and the second straight line is the second width of the last inner coil, and when the first inner coil is sandwiched between the first straight line and the second straight line, a distance between the first straight line and the second straight line is the first width of the first inner coil.
